(19) United States
(12) Patent Application Publication
(10) Pub. No.: US 2017/0161817 A1
(43) Pub. Date: Jun. 8, 2017

(54) COORDINATING ITEM DELIVERY TO A VEHICLE

(71) Applicant: CloudCar, Inc., Mountain View, CA (US)

(72) Inventor: Konstantin Othmer, Los Altos, CA (US)

(21) Appl. No.: 14/960,070

(22) Filed: Dec. 4, 2015

(51) Int. Cl. G06Q 30/06

(52) U.S. Cl. CPC G06Q 30/0631; G06Q 30/0639; G06Q 30/0637

(57) ABSTRACT

A method may include receiving an indication that a user is interested in purchasing an item. The method may also include tracking a location of a vehicle with respect to a delivery site of the item. The vehicle may be associated with the user. The delivery site of the item may be associated with a merchant. The method may further include providing a warning message to the merchant based on the location of the vehicle with respect to the delivery site.

### FIELD

Some embodiments described in the present disclosure generally relate to coordinating item delivery to a vehicle.

### BACKGROUND

Unless otherwise indicated, the materials described in the background section are not prior art to the claims in the present application and are not admitted to be prior art by inclusion in this section.

A purchaser may order an item in a number of ways. For example, the purchaser may order the item on the Internet, in person at a store, or via a phone. The purchaser may also receive a purchased item in a variety of ways. For example, the purchaser may pick up the item at the store, receive the item in the mail, or the item may be delivered to the purchaser's home or business. In some instances, the purchaser may purchase the item in response to an advertisement.

The subject matter claimed in the present disclosure is not limited to embodiments that solve any disadvantages or that operate only in environments such as those described above. Rather, this background is only provided to illustrate one example technology area where some embodiments described may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described in the present disclosure generally relate to coordinating delivery of an item to a vehicle. In an example embodiment, a method may include receiving an indication that a user is interested in purchasing an item. The method may also include tracking a location of a vehicle with respect to a delivery site of the item. The vehicle may be associated with the user. The delivery site of the item may be associated with a merchant. The method may further include providing a warning message to the merchant based on the location of the vehicle with respect to the delivery site.

The object and advantages of the implementations will be realized and achieved at least by the elements, features, and combinations particularly pointed out in the claims.

It is to be understood that both the foregoing general description and the following detailed description are given as examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment configured to coordinate delivery of an item to a vehicle;

FIG. 2 is a flow diagram of an example method of coordinating delivery of an item to a vehicle;

FIG. 3 is a flow diagram of an example method of customizing advertisements for a user; and

FIG. 4 is a block diagram of another example method of coordinating delivery of an item to a vehicle.

### DETAILED DESCRIPTION OF SOME EXAMPLE EMBODIMENTS

Embodiments described in the present disclosure generally relate to coordinating delivery of an item to a vehicle and/or customizing advertisements for a user. In some embodiments, the item may be purchased by a user prior to delivery of the item to the vehicle. In some embodiments, the vehicle may be associated with the user. In some embodiments, coordinating delivery of the item to the vehicle may include tracking a location of the vehicle with respect to a delivery site of the item and providing a warning message to a merchant associated with the delivery site based on the location of the vehicle with respect to the delivery site. Providing the warning message to the merchant based on the location of the vehicle with respect to the delivery site may allow the merchant to deliver the item to the vehicle as soon as the vehicle arrives at the delivery site or shortly thereafter. Thus, coordinating delivery of the item may reduce wait time and allow prompt delivery of the item to the user. In some instances, the user may not even get out of the vehicle in order to obtain the item.

In some embodiments, the warning message may be updated in response to a change in a driving context. For example, in response to the user taking a detour or changing his or her route in the vehicle, the warning message may be updated and sent to the merchant. As another example, in response to traffic affecting the arrival time of the vehicle at the delivery site, the warning message may be updated and sent to the merchant. Also, in some of these and other embodiments, the merchant may choose when or how frequently warning messages are sent to the merchant.

In some embodiments, multiple warning messages may be sent to the merchant based on the location of the vehicle with respect to the delivery site. For example, a warning message may be sent to the merchant that includes an estimated amount of time until the vehicle arrives at the delivery site. In some embodiments, another warning message may be sent to the merchant that indicates the vehicle has arrived at the delivery site.

Some embodiments described in the present disclosure may also include presentation of an advertisement for an item and coordination of delivery of the item to a vehicle based on the user's response to the advertisement. For example, in response to presentation of the advertisement, the user may provide input indicating the user is interested in purchasing the item. In response to determining the user is interested in purchasing the item, a location of a vehicle associated with the user may be tracked with respect to the delivery site of the item. The delivery site of the item may be associated with the merchant. A warning message may be provided to the merchant based on the location of the vehicle with respect to the delivery site.

In some embodiments, the advertisement may be presented to the user in the vehicle. Presenting the advertisement in a vehicle may be different from presenting an advertisement on a smartphone, a tablet, or another suitable client device. Also, responding to the advertisement in the vehicle may be different from responding to an advertisement on a smartphone, a tablet, or another suitable client device. For example, a user that operates a tablet may view an advertisement using a web browser or an application installed on the tablet, and the user may perform one or more gestures on a touch screen of the tablet to respond to the advertisement. However, if the user is driving a vehicle, the presentation of the advertisement and the user's response to the advertisement in the vehicle as disclosed in the present disclosure may be such that they may not distract the user from the driving task. For example, the advertisement may be presented in an audio form so that the user may keep his or her eyes on the road while consuming content of the advertisement. Alternatively or additionally, the system may be configured to allow the user to respond to the advertisement while he or she keeps his or her hands on the steering wheel of the vehicle. In some embodiments, the manner in which the advertisement may be received or responded to such that user distraction with respect to driving may be reduced may be based on one or more user preferences.

Some embodiments described in the present disclosure may allow proactively personalizing and presenting an advertisement in a vehicle. In some embodiments, the advertisement configured to be presented to a user may be customized based on a user preference (e.g., an explicit or implicit user preference), a user profile, an advertisement interaction history associated with the user, a list of items that the user has indicated he or she wants to purchase, tracking data associated with a current journey taken by the user, and/or other customization factors. For example, the advertisement may be personalized for the user based on one or more user interests, likes and/or dislikes, user demographic data, a destination, a weather condition, a traffic condition, a driving scene (e.g., urban, suburban, forest, or another driving scene), advertisement ratings, and/or any other customization factors.

In some embodiments, the advertisement may be presented using a virtual presenter. In these and other embodiments, the virtual presenter may include a virtual person programmed to converse with the user. For example, the virtual presenter may include a virtual radio disc jockey (DJ) that may deliver the advertisement to the user using a machine-synthesized speech. The advertisement may be wrapped in an articulation of the virtual radio DJ configured to deliver the machine-synthesized speech. A voice of the virtual presenter may be obtained from an interactive voice response (IVR) voice, pre-programmed human voices, and/or any other synthetic voices. The virtual presenter may provide commentary, respond to user comments, offer suggestions, and/or provide driving directions to the user in real time.

In some embodiments, audio data that incorporates the advertisement may be created. For example, an audio recording may be synthesized in which the virtual presenter may verbally present the advertisement using a synthetic voice and tone. The advertisement may be presented in the vehicle by playing the audio data in the vehicle. For example, assume that the personalized advertisement relates to purchase of a book. The audio data may include (1) a machine-synthesized speech in which the virtual presenter is programmed to verbally introduce the book using a synthetic voice and (2) an audio excerpt of the book. The audio data may be presented to the user by playing the machine-synthesized speech first and then the audio excerpt of the book using a speaker system.

In some embodiments, the user may consume the advertisement passively with no requirement of interaction. For example, responsive to detecting that the user is on board in the vehicle, an advertisement may be personalized and presented in the vehicle on-the-fly with no requirement of user interaction. In some embodiments, a third-party advertisement provider may provide the advertisement and/or the audio data for presentation in the vehicle. In these and other embodiments, the third-party advertisement provider may include a merchant or other third-party.

Additionally, in some embodiments, the user may interact with the advertisement. For example, the user may provide a verbal input as if the user converses with the virtual presenter that verbally delivers the advertisement to the user. In some embodiments, a microphone mounted or otherwise present in the vehicle may be configured to capture the user's verbal response to the advertisement.

In some embodiments, one or more actions may be performed responsive to the user's verbal input. In some embodiments, in response to determining, based on the user's verbal input, that the user is interested in purchasing the item advertised in the advertisement, a delivery site of the item may be set as a new destination for a navigation application. For example, a doughnut shop may be set as the new destination for the navigation application responsive to the user's verbal input, “I would like to purchase the doughnuts from the doughnut shop you just advertised.”

In some embodiments, in response to determining, based on the user's verbal input, that the user is interested in purchasing an item advertised in the advertisement, a request for the item may be sent to a merchant. For example, in response to the user's verbal input, “Buy me the gift set from the store you just talked about,” a request may be sent to the merchant. Upon approval of the request by the merchant, pre-stored payment information of the user may be sent to the merchant so that the item may be paid for automatically using the user's payment information. In some embodiments, in response to determining, based on the user's verbal input, that the user is interested in purchasing the item advertised in the advertisement, the location of the vehicle may be tracked with respect to the delivery site of the item associated with the merchant and the warning message may be provided to the merchant, which may indicate an estimated amount of time until the user (e.g., via the vehicle) arrives at the delivery site. Additionally or alternatively, the warning message or another warning message that indicates arrival of the vehicle at the delivery site may be provided to the merchant.

Reference will now be made to the drawings to describe various aspects of some example embodiments of the invention. The drawings are diagrammatic and schematic representations of such example embodiments, and are not limiting of the present invention, nor are they necessarily drawn to scale.

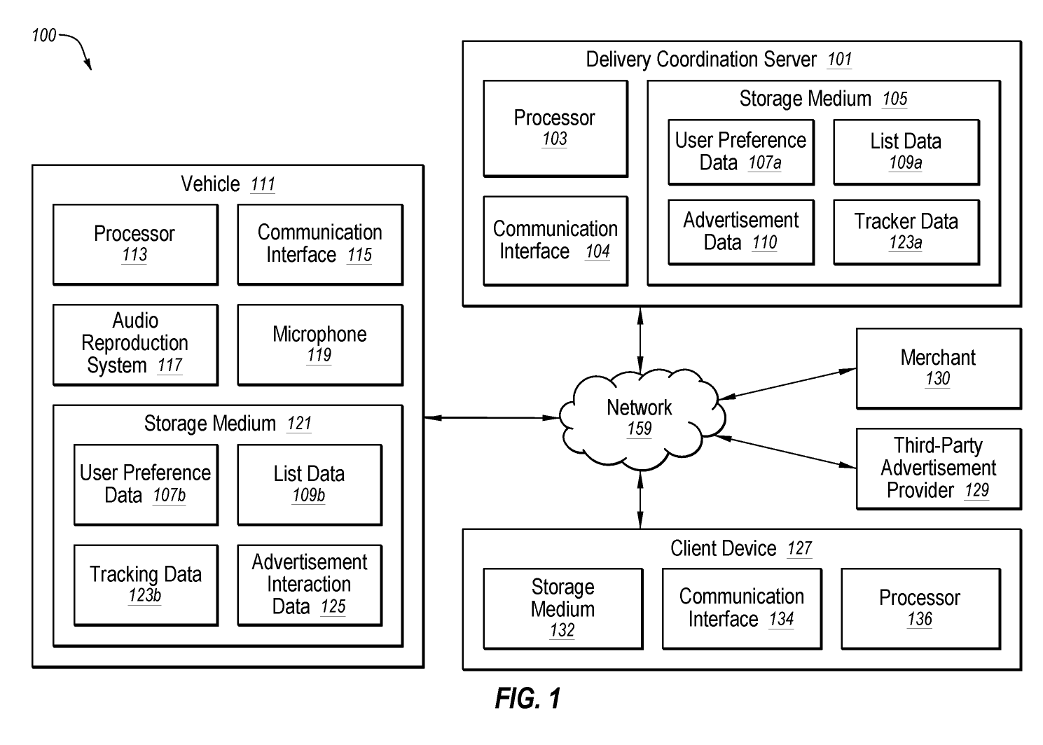

FIG. 1 is a block diagram of an example operating environment 100 that includes a delivery coordination (DC) server 101, a vehicle 111, a client device 127, a third-party advertisement provider 129, and a merchant 130, arranged in accordance with at least one embodiment described in the present disclosure. The vehicle 111, the DC server 101, the client device 127, the third-party advertisement provider 129, and the merchant 130 may cooperate with each other to customize an advertisement for presentation in the vehicle 111 and/or coordinate arrival of the vehicle 111 to a delivery site of the advertised item. In some embodiments, the merchant 130 may include or correspond to the third-party advertisement provider 129.

Although one vehicle 111, one DC server 101, one client device 127, one third-party advertisement provider 129, and one merchant 130 are illustrated in FIG. 1, more generally the operating environment 100 may include one or more vehicles 111, one or more DC servers 101, one or more client devices 127, one or more third-party advertisement providers 129, and one or more merchants 130. In some embodiments, the operating environment 100 may include other servers and/or devices not shown in FIG. 1, such as a map server for providing a map service to the vehicle 111, a traffic server for aggregating and providing traffic information, and/or a weather server for providing weather information. Additionally or alternatively, in some embodiments, the operating environment may not include every element illustrated in FIG. 1.

The operating environment 100 may additionally include a network 159. In general, the network 159 may include one or more wide area networks (WANs) and/or local area networks (LANs) that enable the vehicle 111, the DC server 101, the client device 127, the third-party advertisement provider 129, and/or the merchant 130 to communicate with each other. In some embodiments, the network 159 may include the Internet, including a global internetwork formed by logical and physical connections between multiple WANs and/or LANs. Alternately or additionally, the network 159 may include one or more cellular radio frequency (RF) networks and/or one or more wired and/or wireless networks such as, but not limited to, 802.xx networks, Bluetooth access points, wireless access points, Internet Protocol (IP)-based networks, or the like. For example, the network 159 may include a mobile data network such as third-generation (3G), fourth-generation (4G), long-term evolution (LTE), Voice-over-LTE (VoLTE), or any other mobile data network or combination of mobile data networks. In some embodiments, the network 159 may include a global positioning system (GPS) satellite for providing GPS navigation to the vehicle 111. The network 159 may also include servers that enable one type of network to interface with another type of network.

The DC server 101 may include a hardware server that may include a processor 103, a storage medium 105, and a communication interface 104. The processor 103 may be of any type including, but not limited to, a central processing unit (CPU), a microprocessor (μP), a microcontroller (μC), a digital signal processor (DSP), an application-specific integrated circuit (ASIC), a Field-Programmable Gate Array (FPGA), or any other digital or analog circuitry or combination thereof configured to interpret and/or to execute program instructions and/or to process data. The processor 103 may be configured to execute computer instructions that, when executed, cause the processor 103 to perform or control performance of one or more of the operations described in the present disclosure with respect to the DC server 101. Although illustrated as a single processor in FIG. 1, the processor 103 may include any number of processors configured to perform, individually or collectively, any number of operations described in the present disclosure. Additionally, one or more of the processors may be present on one or more different electronic devices, such as different servers.

The storage medium 105 may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium, or any suitable combination thereof. Accordingly, the storage medium 105 may include a non-transitory computer-readable medium. The storage medium 105 may store computer instructions that may be executed by the processor 103 to perform or control performance of one or more of the operations described in the present disclosure with respect to the DC server 101.

In some embodiments, the storage medium 105 may additionally store one or more of the following: user preference data 107a, list data 109a, advertisement data 109a, and tracking data 123a. In some embodiments, the user preference data 107a may include data that describes user preferences associated with different users. In some embodiments, a user preference associated with a user may indicate what the user likes and/or dislikes. Also, in some embodiments, the user preference data 107a may include data that describes user preferences for a particular type of advertisement, such as, for example, advertisements relating to a food, drinks, sporting goods, or hardware items.

In some embodiments, user preference data 107a may be determined by presenting a question to the user in an audio format. For example, the question may include, “What type of advertisement are you interested in today?” The question may be presented in the audio format by incorporating the question into the audio data. The question may be asked by a virtual presenter, which may deliver the question using machine-synthesized speech. The user may press a button on a steering wheel and/or provide a verbal input to answer the question asked by a virtual presenter. For example, in response to the question, the user may verbally respond, “Italian food.” In these and other embodiments, the vehicle 111 may present one or more personalized advertisements related to Italian food in the vehicle 111. In these and other embodiments, the user preference data 107a may be determined at various times or intervals of time, such as, for example, every day, every week, when the user turns on the vehicle, when the user inputs a user preference, etc.

In some embodiments, the list data 109a may include data that describes one or more items that one or more users on board the vehicle 111 indicated they would like to obtain or purchase. In these and other embodiments, the DC server 101 may extract the list data 109b from one or more of the users' electronic lists, calendars, agendas, files, etc. For example, the DC server 101 may extract the list data 109a from task lists in the user's Outlook Calendar or Google Calendar.

In some embodiments, the advertisement data 110 may include data that describes different types of advertisements. In these and other embodiments, the advertisements may include promotions and deals. In these and other embodiments, the advertisements may be directed towards items including, for example, food, drinks, grocery items, apparel, accessories, entertainment media, health care products, tickets, coupons, and any other items. In some embodiments, the advertisements may include text content, audio content, and/or visual content.

In some embodiments, the tracking data 123a may include data that describes one or more journeys associated with the vehicle 111. For example, the tracking data 123a may include a start point, a destination, a route, a time of departure, a time of arrival, a travel distance, a duration, and any other data related to a historical journey, a current journey, and/or a future journey taken by the vehicle 111.

In these and other embodiments, the tracking data 123a may include data that describes a driving context related to a journey. For example, the driving context may include a destination that the vehicle 111 travels to, a route to the destination, weather conditions along the route, merchants along the route, merchants nearby, traffic conditions along the route, points of interest along the route, driving scenes along the route, one or more users on board in the vehicle 111 (e.g., a driver and/or one or more passengers), and any other context data related to the driving of the vehicle 111. Example driving scenes may include a forest scene, a suburban scene, an urban scene, a mountain scene, a coast scene, and any other suitable driving scene. In these and other embodiments, the tracking data 123a may include any other data related to the driving of the vehicle 111. In some embodiments, the tracking data 123a may include a distance or how far the vehicle 111 is from a delivery site. In some embodiments, the tracking data 123a may include an estimated amount of time until the vehicle 111 arrives at the delivery site. In some embodiments, the tracking data 123a may include whether or not the vehicle 111 has reached the delivery site.

More generally, the storage medium 105 may store any other data for providing the functionality described in the present disclosure. For example, the storage medium 105 may store user profile data that describes user profiles of different users. A user profile associated with a user may include a user name, an email address, education background, working experience, a home address, a work address, interests, hobbies, an occupation, demographic data, and any other user data associated with the user. In another example, the storage medium 105 may store advertisement interaction data that describes how users on board in different vehicles 111 have interacted with advertisements presented in the vehicles 111.

The communication interface 104 may provide any suitable form of communication capability between the DC server 101 and one or more of the vehicle 111, the client device 127, the third-party advertisement provider 129, the merchant 130, and the network 159. For example, the communication interface 104 may include a network interface controller for connecting the DC server 101 to the network 159 via wired connection mechanisms or wireless mechanisms. In some embodiments, the communication interface 104 may include a wireless-fidelity (Wi-Fi) card for providing Wi-Fi connectivity. By way of example and not limitation, the communication interface 104 may be configured to provide, via wireless mechanisms, LAN connectivity, Bluetooth connectivity, Wi-Fi connectivity, near field communication (NFC) connectivity, Machine-to-Machine (M2M) connectivity, Device-to-Device (D2D) connectivity, cellular network connectivity, any other suitable communication capability, or any suitable combination thereof. In some embodiments, the communication interface 104 may include a transmitter and/or a receiver for providing any suitable form of communication capability described in the present disclosure.

In general, the vehicle 111 may include an automobile or any other type of vehicle. The vehicle 111 may include a computing device that includes a processor 113, a communication interface 115, an audio reproduction system 117, a microphone 119, and a storage medium 121. More generally, the vehicle 111 may include other components not illustrated in FIG. 1 (e.g., a touch screen for displaying visual content, buttons such as steering wheel buttons for providing user inputs).

The audio reproduction system 117 may include any device configured to reproduce an audio sound from an input signal. For example, the audio reproduction system 117 may include a speaker system, a pair of headphones, a headset, and/or any other type of audio reproduction devices. The microphone 119 may be configured to capture user voice inputs in the vehicle 111.

Similar to the processor 103 of the DC server 101, the processor 113 may be of any type including, but not limited to, a CPU, a μP, μC, a DSP, an ASIC, an FPGA, or any combination thereof. The processor 113 may be configured to execute computer instructions that, when executed, cause the processor 113 to perform or control performance of one or more of the operations described in the present disclosure with respect to the vehicle 111. Although illustrated as a single processor in FIG. 1, the processor 113 may include any number of processors configured to perform, individually or collectively, any number of operations described in the present disclosure.

Similar to the storage medium 105 of the DC server 101, the storage medium 121 may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. Accordingly, the storage medium 121 may include a non-transitory computer-readable medium. The storage medium 121 may store computer instructions that may be executed by the processor 113 to perform one or more of the operations described in the present disclosure with respect to the vehicle 111.

In some embodiments, the storage medium 121 may store one or more of the following: user preference data 107b, list data 109b, tracking data 123b, and advertisement interaction data 125. More generally, the storage medium 121 may store any other data for providing the functionality described in the present disclosure. For example, the storage medium 121 may store a user profile associated with a user on board in the vehicle 111.

In some embodiments, the user preference data 107b may include data that describes one or more user preferences associated with one or more users on board in the vehicle 111. In some embodiments, the user preference data 107a may include data that describes user preferences for a particular type of advertisement. The user preference data 107b may be uploaded to the DC server 101 and may be stored as part of the user preference data 107a.

In some embodiments, the list data 109b may include data that describes one or more items that the users would like to obtain or purchase. The list data 109b may be uploaded to the DC server 101 and may be stored as part of list data 109a.

In some embodiments, the tracking data 123b may include data that describes one or more journeys associated with the vehicle 111. The tracking data 123b may be uploaded to the DC server 101 and may be stored as part of the tracking data 123a.

In some embodiments, the advertisement interaction data 125 may include data that describes how a user on board in the vehicle 111 interacts with advertisements presented in the vehicle 111. For example, the user may press a button on a steering wheel and/or provide a verbal input to answer a question asked by a virtual presenter. In some embodiments, the advertisement interaction data 125 may include data that describes an advertisement interaction history associated with the user. The advertisement interaction data 125 may be uploaded to the DC server 101 and may be stored as part of the user preference data 107a.

The communication interface 115 may provide any suitable form of communication capability between the vehicle 111 and one or more of the DC server 101, the client device 127, the third-party advertisement provider 129, the merchant 130, and the network 159. The communication interface 115 may provide wired and/or wireless communication capability. For example, the communication interface 115 may include a Wi-Fi card for providing Wi-Fi connectivity. By way of example and not limitation, the communication interface 115 may be configured to provide, via wireless mechanisms, LAN connectivity, Bluetooth connectivity, Wi-Fi connectivity, NFC connectivity, M2M connectivity, D2D connectivity, cellular network connectivity, any other suitable communication capability, or any suitable combination thereof. In some embodiments, the communication interface 115 may include a transmitter and/or a receiver for providing any suitable form of communication capability described in the present disclosure.

The client device 127 may include a computing device that includes a non-transitory storage medium 132, a communication interface 134, and a processor 136, which may be analogous to the storage medium 105, the communication interface 104, and the processor 103, respectively. By way of example, the client device 127 may include a laptop computer, a desktop computer, a tablet computer, a mobile telephone, a personal digital assistant (PDA), a mobile e-mail device, a portable game player, a portable music player, a wearable device, a television with one or more processors embedded therein or coupled thereto, or another electronic device capable of accessing the network 159. In some embodiments, a user may use the client device 127 to configure one or more user preferences and/or one or more default virtual presenters. In some embodiments, the user may use the client device 127 to input or indicate one or more items the user would like to obtain or purchase. In some embodiments, the user may input the items in an electronic list.

In some embodiments, the user may use the client device 127 to indicate an interest in purchasing in an item. In some embodiments, the user may purchase the item using the client device 127. In some embodiments, the user may make a payment through a payment service provider in communication with the user and the merchant 130 through the network 159. The payment service provider may communicate with the user to make a payment using the user's payment information, e.g. the user's credit card information, etc. In some embodiments, the communication interface 134, and the storage medium 132 may be similar to the communication interface 115 and the storage medium 121, respectively.

The third-party advertisement provider 129 may include an entity that may provide advertisements to the vehicle 111 and/or the DC server 101. For example, the third-party advertisement provider 129 may provide advertisements to the vehicle 111 so that the advertisements may be presented in the vehicle 111. In another example, different third-party advertisement providers 129 may provide different advertisements to the vehicle 111 and/or the DC server 101. The vehicle 111 and/or the DC server 101 may score the different advertisements and may present an advertisement with a highest score as a personalized advertisement in the vehicle 111. The third-party advertisement provider 129 may include a processor, a non-transitory storage medium, and network communication capabilities for providing the functionality described in the present disclosure. In some embodiments, the third-party advertisement provider may include or correspond to the merchant 130.

In some embodiments, the merchant 130 may include any entity that receives payment or other consideration. For example, a merchant 130 may request payment for items requested or ordered by the user.

Modifications, additions, or omissions may be made to FIG. 1 without departing from the scope of the present disclosure. For example, in some embodiments, the system 100 may not include one or more of the following: the user preference data 107b, the list data 109b, the tracking data 123b, the advertisement interaction data 125, the third-party advertisement provider 129, the merchant 130, the user preference data 107a, the list data 109a, the advertisement data 110, the audio reproduction system 117, the microphone 119, and the client device 127. In some embodiments, coordination of delivery of the item to the vehicle may occur without presentation of an advertisement. For example, the user may purchase the item using a client device, and in response to the purchase, a vehicle associated with the user may be tracked with respect to the delivery site of the item and one or more warning messages may also be sent to a merchant associated with the delivery site based on the location of the vehicle with respect to the delivery site.

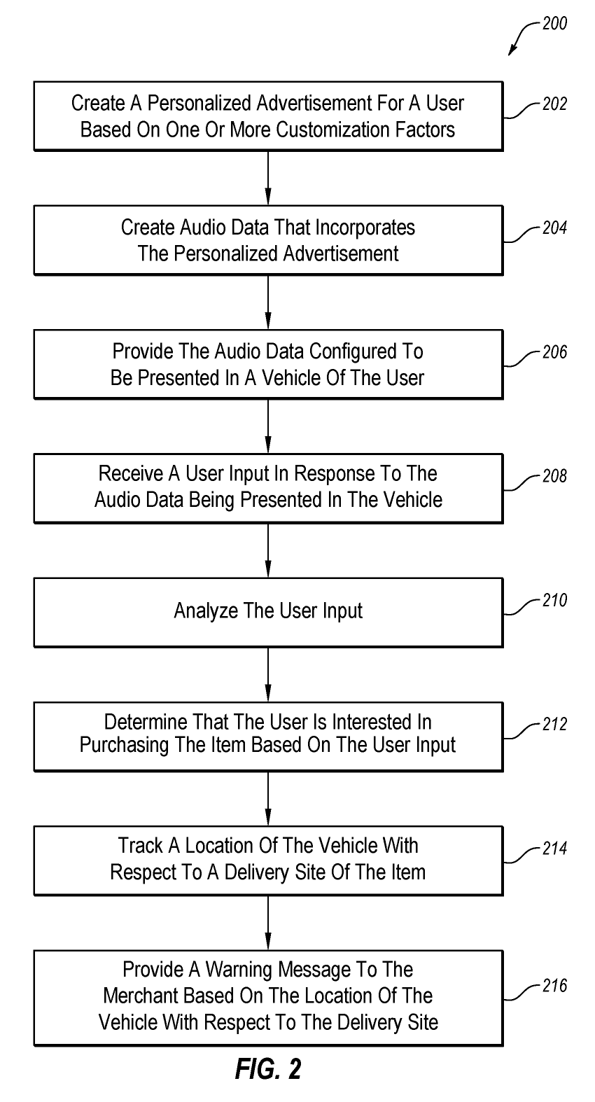

FIG. 2 is a flow diagram of an example method 200 of coordinating delivery of an item to a vehicle, arranged in accordance with at least one embodiment described in the present disclosure. The method 200 may be performed in whole or in part by, e.g., the DC server 101, the vehicle 111, the third-party advertisement provider 129, and/or the merchant 130 of FIG. 1. Although illustrated as discrete blocks, various blocks may be divided into additional blocks, combined into fewer blocks, or eliminated, depending on the desired implementation.

The method 200 may begin at block 202 in which a personalized advertisement may be created for a user based on one or more customization factors. The user may be on board in a vehicle and the personalized advertisement may be created proactively. The one or more customization factors may include a user preference, a user profile, an advertisement interaction history associated with the user, items the user wants to purchase, tracking data, and/or any other factors used to customize advertisements.

In some embodiments, the method 200 may include receiving advertisements from the DC server 101, the third-party advertisement provider 129, the merchant 130, and/or any other advertisement providers. The method 200 may include customizing the received advertisements to generate the personalized advertisement for the user based on one or more user preferences and/or a user profile associated with the user. For example, the method 200 may select a particular advertisement that matches the user's interests from the received advertisements as the personalized advertisement for the user.

Alternatively or additionally, the method 200 may include customizing the received advertisements based on an advertisement interaction history associated with the user. For example, the advertisement interaction history may indicate that if an advertisement related to food from a particular restaurant is presented to the user, the user usually provides an input indicating the user is interested in purchasing the food from the particular restaurant (e.g., the user may comment on the advertisement verbally or press a button on a steering wheel to indicate interest in the advertisement). The method 200 may select an advertisement related to, for example, the particular restaurant from the received advertisements as personalized advertisements for the user.

Alternatively or additionally, the method 200 may include customizing the received advertisements based on tracking data. The tracking data may include a real-time driving context of the current journey taken by the vehicle. For example, if a driving route indicates that the vehicle currently travels or will travel near a particular merchant, the method 200 may select an advertisement related to the particular merchant or from the received advertisements as personalized advertisements for the user. In another example, if a current weather condition is snowy, the method 200 may select one or more advertisements related to snow shovels as personalized advertisements for the user.

Alternatively or additionally, the method 200 may include customizing the received advertisements based on one or more items that the user has indicated he or she wants to purchase. The items may be included in, for example, one or more electronic lists. In some embodiments, the user may enter the items in the lists using a client device. For example, in response to the lists including a hammer, the method 200 may select one or more advertisements related to discounts at hardware stores and/or sales related to hammers.

At block 204, audio data that incorporates the personalized advertisement may be created. For example, the method 200 may include synthesizing a speech in which a virtual presenter, such as, for example, a virtual radio DJ, talks about an advertised item in the personalized advertisement.

At block 206, the method 200 may include providing the audio data configured to be presented in a vehicle such that it may be configured to be presented to the user by being configured to be presented in the vehicle. For example, the audio data may be streamed to the vehicle 111 from the DC server 101, the third-party advertisement provider 129, and/or the merchant 130 so that the audio data may be played in the vehicle 111 using the audio reproduction system 117. Alternatively, the audio data may be generated in the vehicle 111 and presented in the vehicle 111.

Additionally, the method 200 may include determining tracking data associated with the vehicle. Moreover, the method 200 may include determining items the user has indicated he or she wants to purchase by extracting list data from the one or more lists. In some embodiments, the user may input the items the user has indicated he or she wants to purchase into the lists.

In some embodiments, the personalized advertisements and the audio data may be created by one or more of the following: the DC server 101, a third party such as the third-party advertisement provider 129, the merchant 130, and any other advertisement provider.

In some embodiments, the personalized advertisement may be generated proactively. The personalized advertisement may be presented in an audio format by incorporating the personalized advertisement into the audio data. More generally, the personalized advertisements may also be presented in other formats such as a visual format.

In some embodiments, the personalized advertisement may be formatted to appear as advertisements in an interactive radio program in which a virtual radio DJ talks to a listener (e.g., the user in the vehicle 111). For example, the virtual radio DJ may provide commentary, respond to user comments, offer suggestions, and/or provide driving directions for the listener in real time or near real time. The personalized advertisement may be created on-the-fly to match the user preference, the driving destination, and/or other driving context data.

In some embodiments, the personalized advertisement may be referred to as an interactive advertisement. The user may interact with the personalized advertisement by providing a user input. For example, after listening to the advertisement delivered by the virtual presenter, the user may press a steering wheel button (or a button on a panel or infotainment system) and/or may provide a verbal input to respond to the personalized advertisement. In some embodiments, the user may provide a user input to add the personalized advertisement to an electronic list (e.g. a task list), to save the personalized advertisement, to email the personalized advertisement to the user's email box and/or to act upon the personalized advertisement in some other way. For example, the user may provide a verbal input “add this advertisement to my electronic list” while listening to an advertisement. Responsive to the user's verbal input, the method 200 may automatically add the item to the user's electronic list.

At block 208, the method 200 may include receiving a user input in response to the audio data being presented in the vehicle. For example, in some embodiments, the vehicle 111 may receive the user input and send the user input via a network to one or more of the following: the DC server 101, a third party such as the third-party advertisement provider 129, and the merchant 130.

At block 210, the method 200 may include analyzing the user input. At block 212, the method 200 may include determining that the user is interested in purchasing the item based on the user input. For example, user input that includes, “I would like to purchase that item,” or “Yes,” or “Sounds great. I'll take six (6) of those,” may be analyzed, and based on the analysis, it may be determined that the user is interested in purchasing the item.

In some embodiments, the method 200 may include, in response to determining the user is interested in purchasing the item, creating additional audio data that incorporates directions to the delivery site. In some embodiments, the additional audio data may be configured to be presented in the vehicle. In some embodiments, the additional audio data may be provided to the vehicle.

In some embodiments, the method 200 may include, in response to determining the user is interested in purchasing the item, sending a request for the item to the merchant. In some embodiments, the merchant may approve the request. In these and other embodiments, the approval of the request may be received. In these and other embodiments, in response to receiving the approval, additional audio data that incorporates the approval may be created. The audio data may be configured to be presented in the vehicle.

In some embodiments, the method 200 may include, in response to receiving the approval, providing pre-stored payment information to the merchant. For example, pre-stored payment information of the user may be sent to the merchant so that the item may be paid for automatically using the user's payment information. In some embodiments, the method 200 may include updating one or more of the personalized advertisements based on the user input. The method 200 may also include updating the audio data based on updates in the personalized advertisement and/or the virtual presenter personality. For example, the user may provide a verbal input that describes “tell me more about this advertisement” after listening to the audio data related to a particular advertisement for an item. After receiving and analyzing the user's verbal input, the method 200 may update the personalized advertisement to include more description, such as, for example, more description of the item and/or other details of the advertisement, and may generate new audio data that covers the updated personalized advertisement. By way of example, in some embodiments, the new audio data may be presented using the audio reproduction system 117 in the vehicle 111 and/or using an audio reproduction system of a client device (e.g., the client device 127) of the user.

In some embodiments, the method 200 may also include providing audio data that incorporates one or more additional personalized advertisements in response to a request by the user. In some embodiments, the audio data may relate to a particular type of advertisement. For example, the user may provide a verbal input that describes “tell me more advertisements about ski deals.” After receiving and analyzing the user's verbal input, the method 200 may create audio data that incorporates the additional personalized advertisements and provide the audio data configured to be presented using the audio representation system in the vehicle (e.g., the audio representation system 117 of the vehicle 111).

At block 214, in response to determining the user is interested in the item, a location of the vehicle with respect to a delivery site of the item may be tracked. At block 216, a warning message may be provided to the merchant based on the location of the vehicle with respect to the delivery site.

As an example, assume that the audio data includes a personalized advertisement for a coffee shop that is located 4 blocks away from the current location of the user's vehicle. The user may respond with a verbal speech “I want to get a cup of coffee from the coffee shop” after listening to the personalized advertisement. In some embodiments, the method 300 may include receiving and analyzing the user's verbal response. In some embodiments, the method may include determining if the user is interested in purchasing the coffee based on the user input. In some embodiments, the method 200 may provide driving directions to the coffee shop responsive to the user's verbal response. In some embodiments, the method 200 may also include sending a request or message to a computing device associated with the coffee shop to order a cup of coffee for the user. In some embodiments, the method 200 may include creating audio data that incorporates approval by the coffee shop. In some embodiments, the method 200 may also include providing the user's pre-stored payment information to the computing device upon approval of the user so that the cup of coffee may be paid for automatically using the user's payment information. In some embodiments, the method 200 may include synthesizing a speech configured to be delivered by the virtual presenter in which the virtual presenter may confirm the transaction with the user. In some embodiments, the method 200 may include tracking a location of the user's vehicle with respect to the coffee shop. In some embodiments, the method 300 may include providing a warning message to the coffee shop when the vehicle is a certain distance or length of time away from the coffee shop. In some embodiments, the method 200 may include providing a warning message to the coffee shop when the vehicle has arrived at the coffee shop. The user may drive through a drive-through lane of the coffee shop to get the cup of coffee. However, there is no need for the user to hand over a credit card or cash to pay for the cup of coffee in person if the user has already paid as described above.

In yet another example, assume that the audio data includes an advertisement for a gift from a store. The user may respond with a verbal speech “I want to get the gift from the store” after listening to the advertisement. In some embodiments, the method 200 may include receiving and analyzing the user's verbal response and sending a transaction signal to a computing device associated with the online store to place an order for the gift. In some embodiments, the method 200 may also include providing the user's pre-stored payment information to the computing device upon approval of the user so that the gift may be paid for automatically using the user's payment information. In some embodiments, the method 200 may also include tracking the user's vehicle and providing one or more warning messages to the store for timely delivery of the gift to the vehicle.

In some embodiments, the warning message may include an estimated amount of time until the user arrives at the delivery site. In some embodiments, the warning message may be sent to the merchant prior to arrival of the vehicle at the delivery site. In some embodiments, the warning message may be sent to the merchant when the vehicle has arrived at the delivery site. In some embodiments, multiple warning messages may be sent to the merchant based on the location of the vehicle with respect to the delivery site. For example, a first warning message may be sent to the merchant when the vehicle is a certain distance or time away from the delivery site, and a second warning message may be sent to the merchant when the vehicle has arrived at the delivery site. In some embodiments, the warning message may include an estimated amount of time until the user arrives at the delivery site. Alternatively or additionally, in some embodiments, the warning message may include an estimated time at which the user is scheduled to arrive at the delivery site.

In some embodiments, the method 200 may include receiving a requested time for receiving a warning message from the merchant. In these and other embodiments, the requested time may correspond to an estimated amount of time until the user arrives at the delivery site. In some embodiments, the merchant may request that one or more warnings be sent at one or more requested times. For example, the merchant may request that a warning be sent to the merchant twenty (20) minutes before the vehicle is scheduled to arrive at the delivery site.

In some embodiments, the method 200 may include providing an updated warning message to the merchant in response to a change in a driving context. In some embodiments, the driving context may include one or more of the following: a journey destination, a route, a weather condition, a traffic condition, and a driving scene along the route. In some instances, the driving context may affect the estimated arrival time of the vehicle at the delivery site. In some embodiments, an updated estimated arrival time or time until arrival may be provided to the merchant based on the change in the driving context.

It may be appreciated that the operations described with respect to the method 200 may be implemented in a differing order than that described. Furthermore, the outlined steps and operations are only provided as examples, and some of the steps and operations may be optional, combined into fewer steps and operations, or expanded into additional steps and operations without detracting from the essence of the disclosed embodiments. For example, in some embodiments, block 214 and block 216 and other operations may not be performed until the request for the item has been sent to the merchant and/or the merchant has approved the request. Also, in some embodiments, a delivery site of the item may not be set as a new destination for a navigation application until the request for the item has been sent to the merchant and/or the merchant has approved the request.

Some embodiments disclosed in the present disclosure include an article of manufacture such as a non-transitory computer storage medium having instructions stored thereon that are executable by a computing device to perform or control performance of operations included in the method 200 of FIG. 2, such as the operations illustrated by blocks 202, 204, 206, 208, 210, 212, 214, and/or 216 in FIG. 2, and/or variations thereof. The non-transitory computer storage medium may be included in or may be accessible to the DC server 101, the third-party advertisement provider 129, the merchant 130, and/or the vehicle 111 of FIG. 1, such as the storage medium 105 or the storage medium 121. The computing device may include a processor or other processing device of the DC server 101, the vehicle 111 or the third-party advertisement provider 129, such as the processor 103 or the processor 113.

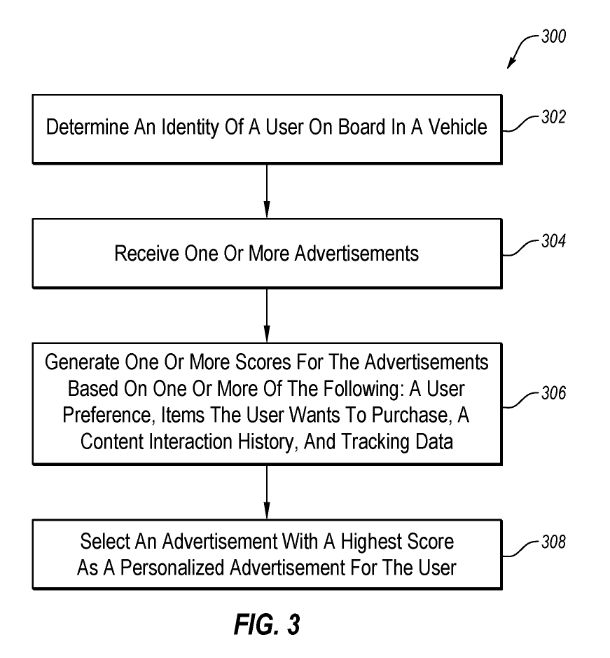

FIG. 3 is a flow diagram of an example method of customizing advertisements for a user, arranged in accordance with at least one embodiment described in the present disclosure. The method 300 may be performed in whole or in part by, e.g., the DC server 101, the third-party advertisement provider 129, the merchant 130, and/or the vehicle 111 of FIG. 1. Although illustrated as discrete blocks, various blocks may be divided into additional blocks, combined into fewer blocks, or eliminated, depending on the desired implementation.

The method 300 may begin at block 302 in which an identity of a user on board in a vehicle may be determined. In some embodiments, the user may be a driver or a passenger on board in a vehicle. User data such as a user profile, a user preference, an advertisement interaction history of the user, tracking data, items the user has indicated he or she wants to purchase, which may be stored electronically in a list, and any other data related to the user may be accessed from the storage medium 105 and/or the storage medium 121 using the identity of the user.

At block 304, one or more advertisements may be received. For example, the advertisements may be received from the DC server 101, the third-party advertisement provider 129, the merchant 130, and/or any other advertisement sources. In some embodiments, the advertisements may include promotions and deals. In some embodiments, the advertisements may be directed towards items including, for example, food, drinks, grocery items, apparel, accessories, entertainment media, health care products, tickets, coupons, and any other items.

At block 306, one or more scores may be generated for each of the advertisements. Each score associated with a corresponding advertisement may be generated based on an advertisement rating related to the advertisement, the user preference, the advertisement interaction history, the tracking data, the items the user wants to purchase, and/or any other customization factors. For example, the tracking data may indicate that the user currently drives to a destination along a travel route. A first advertisement may describe a promotion at a store along the travel route. A second advertisement may describe restaurant deals in a city in which the user is located. A first score generated for the first advertisement may be higher than a second score generated for the second advertisement since the first advertisement may be more convenient based on the user's current driving task.

In another example, a first advertisement may relate to coffee from a first store. A second advertisement may relate to coffee from a second store. If the advertisement interaction history indicates that the user has interacted with advertisements from the first store more frequently than advertisements from the second store, a higher score may be generated for the first advertisement than that of the second advertisement.

At block 306, a particular advertisement with a highest score may be selected from the advertisements as a personalized advertisement for the user.

It may be appreciated that the operations described with respect to the method 300 may be implemented in a differing order than that described. Furthermore, the outlined steps and operations are only provided as examples, and some of the steps and operations may be optional, combined into fewer steps and operations, or expanded into additional steps and operations without detracting from the essence of the disclosed embodiments. For example, in some embodiments, block 304 may be performed before block 302.

Some embodiments disclosed in the present disclosure include an article of manufacture such as a non-transitory computer storage medium having instructions stored thereon that are executable by a computing device to perform operations included in the method 300 of FIG. 3, such as the operations illustrated by blocks 302, 304, 306, and/or 308 in FIG. 3, and/or variations thereof. The non-transitory computer storage medium may be included in or may be accessible to the DC server 101, the third-party advertisement provider 129, the merchant 130, and/or the vehicle 111 of FIG. 1, such as the storage medium 105 or the storage medium 121. The computing device may include a processor or other processing device of the DC server 101, the vehicle 111 or the third-party advertisement provider 129, such as the processor 103 or the processor 113.

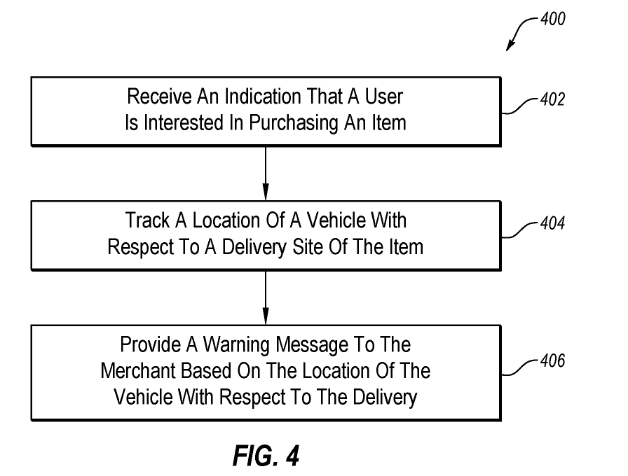

FIG. 4 is a block diagram of another example method of coordinating delivery of an item to a vehicle, arranged in accordance with at least one embodiment described in the present disclosure. The method 400 may be performed in whole or in part by, e.g., the DC server 101, the third-party advertisement provider 129 of FIG. 1. Although illustrated as discrete blocks, various blocks may be divided into additional blocks, combined into fewer blocks, or eliminated, depending on the desired implementation.

At block 402, an indication that a user is interested in purchasing an item may be received. In some embodiments, the indication may include, for example, purchase of the item, a verbal input, or non-verbal input. In some embodiments, the user may indicate interest in purchasing an item by pressing a button on a steering wheel and/or providing a verbal input to answer the question asked by the virtual presenter. In some embodiments, the indication may be made by the user using a laptop computer, a desktop computer, a tablet computer, a mobile telephone, a personal digital assistant (PDA), a mobile e-mail device, a portable game player, a portable music player, a wearable device, a television with one or more processors embedded therein or coupled thereto, or another electronic device capable of accessing the network.

At block 404, a location of a vehicle with respect to a delivery site of the item may be tracked. In some embodiments, the location of the vehicle may be tracked according to the tracking described above with respect to FIG. 1.

At block 406, a warning message may be provided to the merchant based on the location of the vehicle with respect to the delivery site. In some embodiments, the warning message may be provided as described above with respect to FIG. 1.

It may be appreciated that the operations described with respect to the method 400 may be implemented in a differing order than that described. Furthermore, the outlined steps and operations are only provided as examples, and some of the steps and operations may be optional, combined into fewer steps and operations, or expanded into additional steps and operations without detracting from the essence of the disclosed embodiments.

Some embodiments disclosed in the present disclosure include an article of manufacture such as a non-transitory computer storage medium having instructions stored thereon that are executable by a computing device to perform operations included in the method 400 of FIG. 4, such as the operations illustrated by blocks 402, 404, and/or 406 in FIG. 4, and/or variations thereof. The non-transitory computer storage medium may be included in or may be accessible to the DC server 101, the third-party advertisement provider 129, the merchant 130, and/or the vehicle 111 of FIG. 1, such as the storage medium 105 or the storage medium 121. The computing device may include a processor or other processing device of the DC server 101, the vehicle 111 or the third-party advertisement provider 129, such as the processor 103 or the processor 113.

The present disclosure is not to be limited in terms of the particular embodiments described in the present disclosure, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in the present disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used in the present disclosure is for the purpose of describing particular embodiments only, and is not intended to be limiting.

With respect to the use of substantially any plural and/or singular terms in the present disclosure, those having skill in the art can translate from the plural to the singular and/or from the singular to the plural as is appropriate to the context and/or application. The various singular/plural permutations may be expressly set forth in the present disclosure for sake of clarity.

Further, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
creating a personalized advertisement for an item, wherein the personalized advisement is personalized for a user based on one or more customization factors;
creating audio data that incorporates the personalized advertisement;
providing the audio data configured to be presented in a vehicle associated with the user;
receiving a user input in response to the audio data being presented in the vehicle;
analyzing the user input;
determining whether the user is interested in purchasing the item based on the user input; and
in response to determining the user is interested in purchasing the item:
tracking a location of the vehicle with respect to a delivery site of the item, wherein the delivery site of the item is associated with a merchant; and
providing a warning message to the merchant based on the location of the vehicle with respect to the delivery site.

2. The method of claim 1, further comprising:
in response to determining the user is interested in purchasing the item, sending a request for the item;
receiving approval of the request;
in response to receiving the approval, creating additional audio data that incorporates the approval; and
providing the additional audio data configured to be presented in the vehicle.

3. The method of claim 2, further comprising in response to receiving the approval, providing pre-stored payment information to the merchant.

4. The method of claim 1, further comprising:
in response to determining the user is interested in purchasing the item, creating additional audio data that incorporates directions to the delivery site; and
providing the additional audio data configured to be presented in the vehicle.

5. The method of claim 1, wherein the user input includes verbal input.

6. The method of claim 1, wherein the warning message includes an estimated amount of time until the user arrives at the delivery site.

7. The method of claim 5, further comprising in response to determining the user is interested in purchasing the item, providing another warning message to the merchant in response to the vehicle arriving at the delivery site.

8. The method of claim 1, further comprising receiving a requested time for receiving the warning message, wherein the requested time corresponds to an estimated amount of time until the user arrives at the delivery site.

9. The method of claim 1, further comprising providing an updated warning message to the merchant in response to a change in a driving context.

10. The method of claim 1, wherein the driving context includes one or more of the following: a journey destination, a route, a weather condition, a traffic condition, and a driving scene along the route.

11. A system for coordinating delivery of an item to a vehicle, comprising a processor configured to:
receive an indication that a user is interested in purchasing an item;
track a location of a vehicle with respect to a delivery site of the item, wherein the vehicle is associated with the user, wherein the delivery site is associated with a merchant; and
provide a warning message to the merchant based on the location of the vehicle with respect to the delivery site.

12. The system of claim 11, wherein the processor is further configured to:
in response to determining the user is interested in purchasing the item, create audio data that incorporates directions to the delivery site; and
provide the additional audio data configured to be presented in the vehicle.

13. The system of claim 11, wherein the processor is further configured to provide another warning message to the merchant when the vehicle arrives at the delivery site.

14. The system of claim 11, wherein the processor is further configured to receive a requested time for receiving the warning message, wherein the requested time corresponds to an estimated amount of time until the user arrives at the delivery site.

15. One or more non-transitory computer-readable media that include computer-readable instructions stored thereon that are executable by one or more processors to perform or control performance of operations, the operations comprising:
creating a personalized advertisement for an item, wherein the personalized advisement is personalized for a user based on one or more customization factors;
creating audio data that incorporates the personalized advertisement;
providing the audio data configured to be presented in a vehicle associated with the user;
receiving a user input in response to the audio data being presented in the vehicle;
analyzing the user input;
determining whether the user is interested in purchasing the item based on the user input; and
in response to determining the user is interested in purchasing the item:
tracking a location of the vehicle with respect to a delivery site of the item, wherein the delivery site of the item is associated with a merchant; and
providing a warning message to the merchant based on the location of the vehicle with respect to the delivery site.

16. The one or more non-transitory computer-readable media of claim 15, wherein the operations further comprise:
in response to determining the user is interested in purchasing the item, sending a request for the item;
receiving approval of the request;
in response to receiving the approval, creating additional audio data that incorporates the approval; and
providing the additional audio data configured to be presented in the vehicle.

17. The one or more non-transitory computer-readable media of claim 16, wherein the operations further comprise in response to receiving the approval, providing pre-stored payment information to the merchant.

18. The one or more non-transitory computer-readable media of claim 15, wherein warning message includes an estimated amount of time until the user arrives at the delivery site.

19. The one or more non-transitory computer-readable media of claim 15, wherein the operations further comprise in response to determining the user is interested in purchasing the item, providing another warning message to the merchant when the vehicle arrives at the delivery site.

20. The one or more non-transitory computer-readable media of claim 15, wherein the operations further comprise receiving a requested time for receiving the warning message, wherein the requested time corresponds to an estimated amount of time until the user arrives at the delivery site.
